(19) United States
(12) Patent Application Publication
(10) Pub. No.: US 2023/0304350 A1
(43) Pub. Date: Sep. 28, 2023

(54) POWER SIDE DOOR ACTUATOR HAVING RACK AND PINION DRIVE

(71) Applicant: MAGNA CLOSURES INC., Newmarket (CA)

(72) Inventors: Johannes KAPLAN, Newmarket (CA); Oliver BOFINGER, Newmarket (CA)

(21) Appl. No.: 18/111,527

(22) Filed: Feb. 17, 2023

Related U.S. Application Data
(60) Provisional application No. 63/313,670, filed on Feb. 24, 2022.

(51) Int. Cl. E05F 15/616

(52) U.S. Cl. CPC E05F 15/616; E05Y 2201/10; E05Y 2201/716; E05Y 2201/722; E05Y 2900/531

(57) ABSTRACT

A power actuator for moving a closure panel of a motor vehicle between closed and open positions is provided. The power actuator includes an electric motor and a pinion gear supported for rotation in response to rotation of a motor drive shaft of the electric motor. An extensible rack having a plurality of rack teeth is configured for meshed engagement with pinion teeth of the pinion gear. The extensible rack is configured to move between a retracted position, corresponding to the closed position of the closure panel, and an extended position, corresponding to the open position of the closure panel, in response to rotation of the pinion gear. The rack teeth have circumferentially extending, arcuate outer peaks, as viewed along a longitudinal axis of the extensible rack to allow relative pivotal movement between the rack teeth and the pinion teeth, thereby inhibiting jamming between the extensible rack the pinion gear.

### CROSS-REFERENCE TO RELATED APPLICATIONS

This application claims the benefit of U.S. Provisional Application Ser. No. 63/313,670, filed Feb. 24, 2022, which is incorporated herein by reference in its entirety.

### FIELD

The present disclosure relates to a power actuator for a vehicle closure. More specifically, the present disclosure relates to a power actuator assembly for a vehicle side door.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis extending along an edge of a shut face of the passenger door. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. Such swinging passenger doors (“swing doors”) may be moveable by power closure member actuation systems. Specifically, the power closure member actuation system can function to automatically swing the passenger door about its pivot axis between the open and closed positions, to assist the user as he or she moves the passenger door, and/or to automatically move the passenger door in between closed and open positions for the user.

Typically, power closure member actuation systems include a power-operated device such as, for example, an electric motor and a rotary-to-linear conversion device that are operable for converting the rotary output of the electric motor into translational movement of an extensible member. The electric motor and the conversion device are typically mounted to the passenger door and the distal end of the extensible member is fixedly secured to the vehicle body. The electric motor drives a pinion gear arranged in meshed engagement with teeth of a rack. The pinion gear is known to be provided as a spur gear, while the teeth of the rack are known to be formed along a flat face of a rectangular rack, as viewed along a longitudinal axis thereof. Although aforementioned rack and pinion gear can be effective to drive the swing door between its closed and open positions, any tendency of misalignment of the pinion teeth and the rack teeth, such as can result by slight tilting of the swing door relative to its pivot axis, can result in unwanted binding between the rack and pinion gear, thus negatively impacting the ability for smooth movement of the swing door. Furthermore, binding between the rack and pinion gear also places strain on the motor and other greatrain components.

In view of the above, there remains a need to develop power closure member actuation systems which address and overcome limitations and drawbacks associated with known power closure member actuation systems as well as to provide increased convenience and enhanced operational capabilities.

### SUMMARY

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

In one aspect, the present disclosure is directed to a vehicle closure panel and a powered actuator for the vehicle closure panel which advances the art and improves upon currently known vehicle closure panels and powered actuators for such vehicle closure panels.

In another aspect, the present disclosure is directed to a method of constructing a powered actuator for a closure panel of a motor vehicle which advances the art and improves upon currently known methods of constructing powered actuators for vehicle closure panels.

It is a related aspect to provide a powered actuator that is reliable, compact, and economical in manufacture, assembly, and in use.

It is a related aspect to provide a powered actuator that reduces the moment of inertia of a closure panel, thereby facilitating reliable opening and closing of the closure panel with a reduced size electric motor.

It is a related aspect to provide a powered actuator that inhibits jamming between a pinion gear and an extensible rack of the powered actuator.

It is a related aspect to provide a powered actuator that is readily adaptable for use with a variety of closure panel configurations, both during original equipment manufacture and after-market.

In accordance with these and other aspects, a power actuator for moving a closure panel of a motor vehicle between a closed position and an open position is provided. The power actuator includes a housing and an electric motor supported by the housing, with the electric motor being configured to rotate a motor drive shaft. A pinion gear is operably supported for rotation in response to rotation of the motor drive shaft. The pinion gear has a plurality of pinion teeth and, and an extensible rack having a plurality of rack teeth is configured for meshed engagement with the pinion teeth. The extensible rack has a proximal end configured to be pivotably coupled to one of a vehicle body or the closure panel. The extensible rack is configured to move between a retracted position, corresponding to the closed position of the closure panel, and an extended position, corresponding to the open position of the closure panel, in response to rotation of the pinion gear. The rack teeth of the extensible rack have circumferentially extending, arcuate outer peaks, as viewed along a longitudinal axis of the extensible rack. The arcuate outer peaks of the rack teeth allow relative pivotal movement between the rack teeth and the pinion teeth, thereby inhibiting jamming between the extensible rack the pinion gear.

In accordance with another aspect of the disclosure, the rack teeth are formed in a cylindrical outer surface of said extensible rack.

In accordance with another aspect of the disclosure, each of the rack teeth extends from the arcuate outer peak radially inwardly toward the longitudinal axis to a linearly straight root.

In accordance with another aspect of the disclosure, the linearly straight roots extend generally transversely to the longitudinal axis.

In accordance with another aspect of the disclosure, the pinion gear includes a first gear and a second gear in axially stacked relation with one another for rotation about a common axis. The first gear has a plurality of first pinion teeth and the second gear has a plurality of second pinion teeth. The first pinion teeth and the second pinion teeth are arranged in pairs of pinion teeth in side-by-side relation with one another, wherein each of the pairs of pinion teeth are configured for meshed receipt between an adjacent pair of the rack teeth as the extensible rack moves between the retracted position and the extended position.

In accordance with another aspect of the disclosure, the first and second gears are coupled to one another by a pinion gear biasing member. The pinion gear biasing member imparts a bias on the first and second gears. The bias tends to move the first pinion teeth and the second pinion teeth away from mirrored relation with one another.

In accordance with another aspect of the disclosure, while the pinion gear is in a rest state, the bias moves a meshed one of the first pinion teeth into engagement with one of the adjacent pair of rack teeth and a meshed one of the second pinion teeth into engagement with another of the adjacent pair of rack teeth.

In accordance with another aspect of the disclosure, while the pinion gear is in a driven state, the bias is overcome, wherein the first pinion teeth and the second pinion teeth are brought into axially aligned, mirrored relation with one another.

In accordance with another aspect of the disclosure, at least one bearing can be engaged with and support the extensible rack.

In accordance with another aspect of the disclosure, the at least one bearing can include a first bearing on one side of the pinion gear and a second bearing on an opposite side of the pinion gear.

In accordance with another aspect of the disclosure, the at least one bearing has a circular inner bearing surface supporting the extensible rack for sliding movement therealong.

In accordance with another aspect of the disclosure, a method of configuring a power actuator to inhibit binding of an extensible rack of the power actuator while moving a closure panel of a motor vehicle between a closed position and an open position is provided. The method includes: configuring an electric motor to rotate a pinion gear having a plurality of pinion teeth in response to rotation of a drive shaft of the electric motor; configuring a proximal end of the extensible rack to be pivotably coupled to one of a vehicle body or the closure panel and arranging a plurality of rack teeth of the extensible rack for meshed engagement with the pinion teeth to move the extensible rack between a retracted position, corresponding to the closed position of the closure panel, and an extended position, corresponding to the open position of the closure panel, in response to rotation of the pinion gear; and configuring the rack teeth having circumferentially extending, arcuate outer peaks, as viewed along a longitudinal axis of the extensible rack, wherein the arcuate outer peaks allow relative pivotal movement between the rack teeth and the pinion teeth.

In accordance with a further aspect of the disclosure, the method can further include providing the rack teeth being formed in a cylindrical outer surface of the extensible rack.

In accordance with a further aspect of the disclosure, the method can further include providing the rack teeth having linearly straight roots.

In accordance with a further aspect of the disclosure, the method can further include providing the linearly straight roots extending generally transversely to the longitudinal axis.

In accordance with a further aspect of the disclosure, the method can further include configuring the pinion gear having a first gear and a second gear in axially stacked relation with one another for rotation about a common axis, with the first gear having a plurality of first pinion teeth and the second gear having a plurality of second pinion teeth, and arranging the first pinion teeth and the second pinion teeth in side-by-side pairs of pinion teeth with the pairs of pinion teeth being configured for meshed receipt between an adjacent pair of the rack teeth as the extensible rack is moved between the retracted position and the extended position.

In accordance with a further aspect of the disclosure, the method can further include coupling the first and second gears to one another with a pinion gear biasing member, and configuring the pinion gear biasing member to impart a bias on the first and second gears to move the first pinion teeth and the second pinion teeth away from mirrored relation with one another.

In accordance with a further aspect of the disclosure, the method can further include, while the pinion gear is in a rest state, configuring the bias to move a meshed one of the first pinion teeth into engagement with one of the adjacent pair of rack teeth and a meshed one of the second pinion teeth into engagement with another of the adjacent pair of rack teeth.

In accordance with a further aspect of the disclosure, the method can further include configuring the bias to be overcome while the pinion gear is driving the extensible rack such that the first pinion teeth and the second pinion teeth become axially aligned in mirrored relation with one another.

In accordance with a further aspect of the disclosure, the method can further include supporting the extensible rack with a bearing surface of at least one bearing.

In accordance with a further aspect of the disclosure, the method can further include supporting the extensible rack with a bearing surface of a first bearing on one side of the pinion gear and with a bearing surface of a second bearing on an opposite side of the pinion gear.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. Other advantages of the present embodiments than discussed expressly herein will be readily appreciated, as the same becomes better understood by reference to the following detailed description and appended claims when considered in connection with the accompanying drawings, wherein:

FIG. 1 is a side view of an example motor vehicle equipped with a power closure member actuation system situated between the front passenger swing door and a vehicle body, according to aspects of the disclosure;

FIG. 2 is a broken away inner side view of a closure member shown in FIG. 1, with various components removed for clarity purposes only, in relation to a portion of the vehicle body and which is equipped with the power closure member actuation system, according to aspects of the disclosure;

FIG. 3A is a side view of a power actuator of the power closure member actuation system of FIGS. 1 and 2;

FIG. 3B is a top perspective view of the power actuator of FIG. 3A;

FIG. 3C is a view similar to FIG. 3B with a mounting bracket removed therefrom for clarity of an end of an extensible rack thereof only;

FIGS. 4A and 4B are sides views of the power actuator of FIG. 3 illustrating orientations thereof for use in respective driver and passenger swing doors of the motor vehicle of FIG. 1;

FIG. 5 is a cross-section top view of the power actuator shown installed in a swing door of the motor vehicle of FIG. 1;

FIG. 6A is a schematic cross-sectional view taken generally along a plane extending transversely to a longitudinal axis of an extensible rack of the power actuator of FIG. 3A illustrating a pinion gear in meshed engagement with the extensible rack while in a non-pivoted orientation;

FIG. 6B is a view similar to FIG. 6A illustrating the extensible rack in a pivoted orientation relative to the pinion gear;

FIG. 7 is a view similar to FIG. 3A with a mounting bracket removed for clarity purposes only to illustrate a protective bellows attached to pivot link and housing of power actuator;

FIG. 7A is a cross-sectional view of an optional electromagnetic brake of the power actuator of FIG. 7;

FIG. 7B illustrates a perspective, side, and end view of an extensible rack of the power actuator;

FIG. 8 is a schematic view of the power actuator of FIG. 7;

FIG. 9 is an exploded view of a motor/geartrain assembly with clutch/brake assembly of a power actuator constructed in accordance with an aspect of the disclosure;

FIG. 10 is a side view illustrating a mechanical energy dampener assembly of the extensible rack of a power actuator constructed in accordance with an aspect of the disclosure;

FIGS. 11 and 11A are views similar to FIG. 3A illustrating a power actuator constructed in accordance with another aspect of the disclosure;

FIG. 12 is a view similar to FIG. 3A illustrating a power actuator having an electronic control unit integrated into a housing thereof in accordance with another aspect of the disclosure;

FIG. 12A is a top view of FIG. 12;

FIG. 13 is an exploded view of a pinion gear of a power actuator constructed in accordance with another aspect of the disclosure;

FIG. 13A is a schematic view illustrating pinion teeth of the pinion gear of FIG. 13 in meshed engagement with rack teeth of an extensible rack of a power actuator constructed in accordance with another aspect of the disclosure; and

FIG. 14 is a flow diagram illustrating a method of configuring a power actuator to inhibit binding of an extensible rack of the power actuator while moving a closure panel of a motor vehicle between a closed position and an open position in accordance with another aspect of the disclosure.

Corresponding reference numerals indicate corresponding parts throughout the several views of the drawings.

### DETAILED DESCRIPTION OF EXAMPLE EMBODIMENTS

An example embodiment of a power actuator for a motor vehicle closure panel and method of inhibiting binding movement of an extensible rack thereof will now be described more fully with reference to the accompanying drawings. To this end, the example embodiment of a power actuator is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

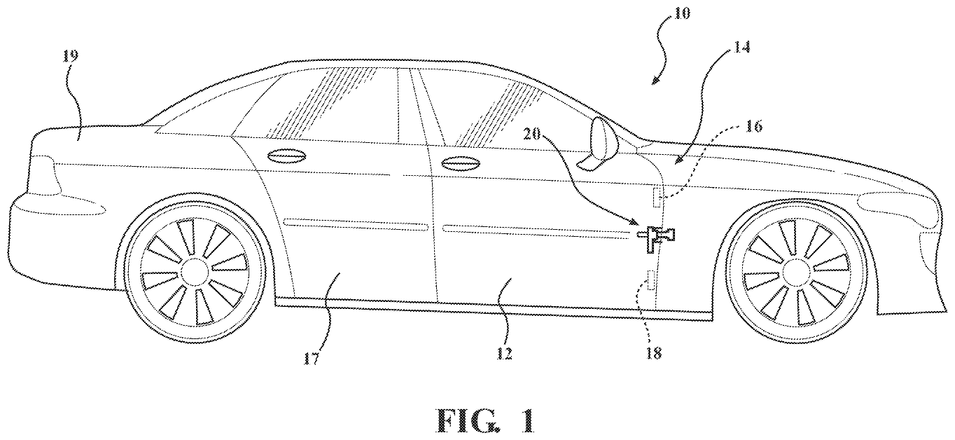

Referring initially to FIG. 1, an example motor vehicle 10 is shown to include a first passenger swing door 12 pivotally mounted to a vehicle body 14 via an upper door hinge 16 and a lower door hinge 18 which are shown in phantom lines. In accordance with the present disclosure, a power closure member actuation system 20 is pivotally connected between first passenger door 12 and the vehicle body 14. In accordance with a preferred configuration, power closure member actuation system 20 generally includes a power-operated actuator mechanism, also referred to as power actuator or actuator 22, secured within an internal cavity of passenger door 12, and a rotary drive mechanism that is driven by the power actuator 22 and is drivingly coupled to the vehicle body 14. Driven rotation of the rotary drive mechanism causes controlled pivotal movement of passenger door 12 relative to vehicle body 14 via non-rotating translation of an extensible rack 42. In accordance with this preferred configuration, the power actuator mechanism 22, by way of example and without limitation, is pivotally coupled to and in close proximity with the shut face of the door 12 between hinges 16, 18 while the rotary drive mechanism is pivotally coupled to the vehicle body 14. However, those skilled in the art will recognize that alternative packaging configurations for power closure member actuation system 20 are available to accommodate available packaging space. One such alternative packaging configuration may include mounting the power actuator 22 to vehicle body 14 and drivingly interconnecting the rotary drive mechanism to the door 12.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system 20 can also be associated with any other closure member (e.g., door or liftgate) of vehicle 10 such as rear passenger doors 17 and decklid 19 as examples.

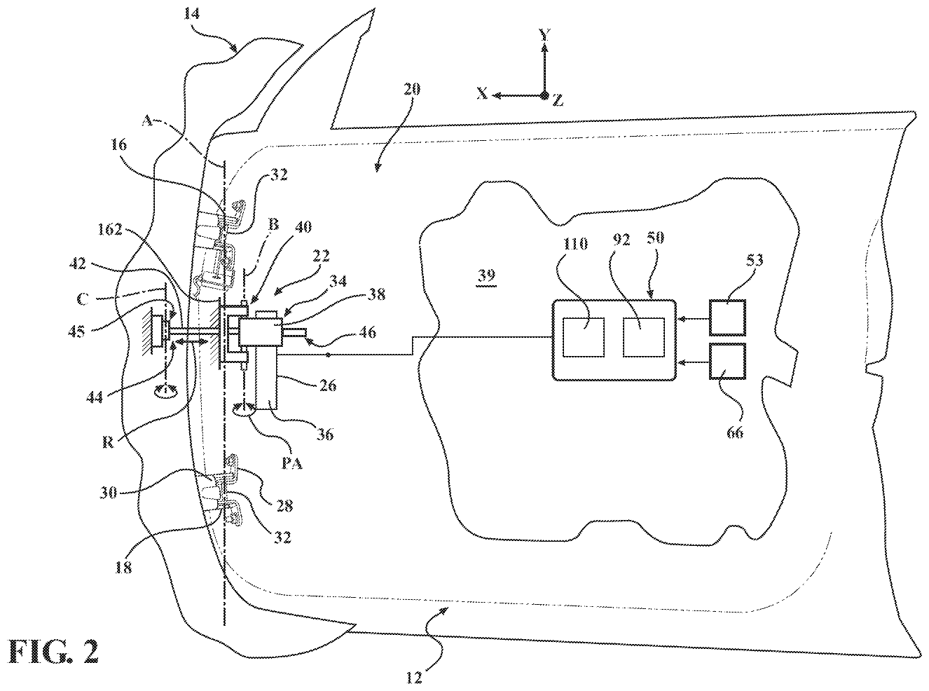

Power closure member actuation system 20 is generally shown in FIG. 2 and, as mentioned, is operable for controllably pivoting vehicle swing door 12 relative to vehicle body 14 between an open position and a closed position. As shown in FIG. 2, lower hinge 18 of power closure member actuation system 20 includes a door hinge strap 28 connected to vehicle door 12 and a body hinge strap 30 connected to vehicle body 14. Door hinge strap 28 and body hinge strap 30 of lower door hinge 18 are interconnected along a generally vertically-aligned pivot axis A via a hinge pin 32 to establish the pivotable interconnection between door hinge strap 28 and body hinge strap 30. However, any other mechanism or device can be used to establish the pivotable interconnection between door hinge strap 28 and body hinge strap 30 without departing from the scope of the subject disclosure.

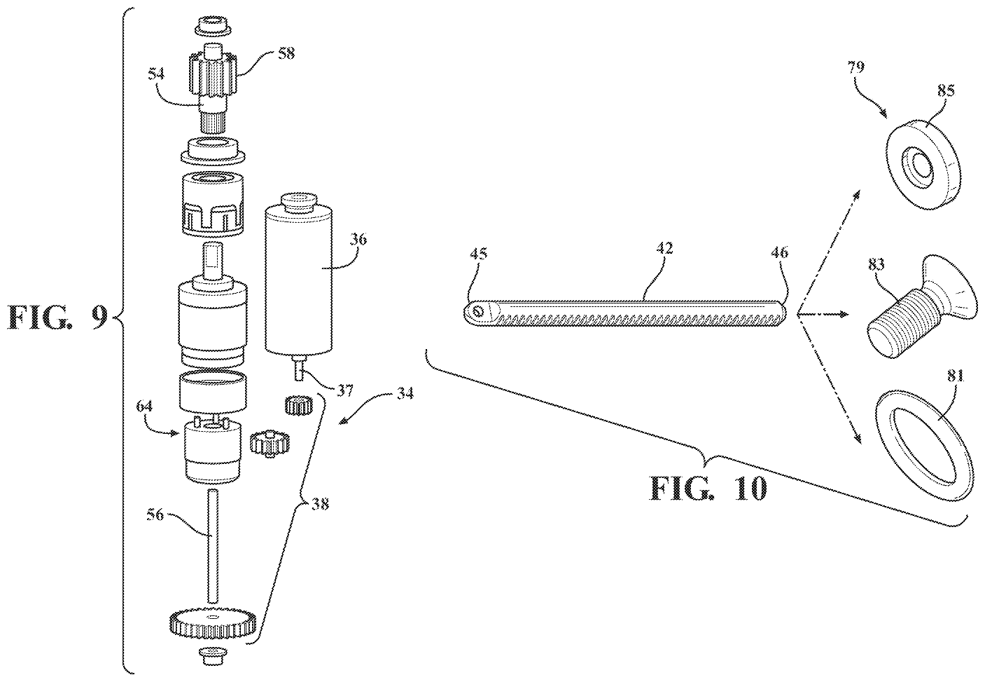

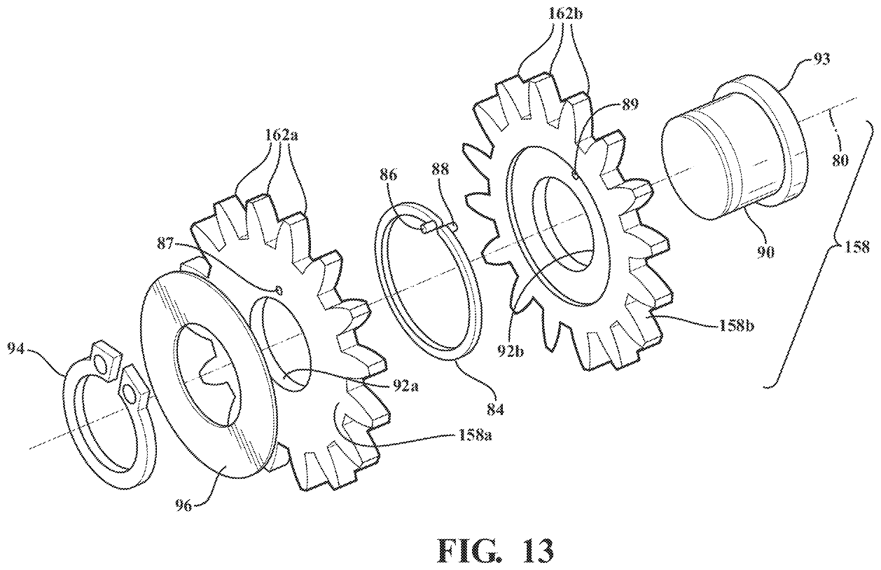

As best shown in FIG. 2, power closure member actuation system 20 includes the power actuator 22 having a motor and geartrain assembly 34 that is connectable to vehicle door 12. Illustratively, the power closure member actuation system 20 is pivotally connected to the shut face 162 of the vehicle door 12. Motor and geartrain assembly 34 is configured to generate a rotational force about pivot axis A. In the preferred embodiment, motor and geartrain assembly 34 includes an electric motor 36 disposed in and supported by a housing 26 configured to rotatably drive a motor shaft 37 in opposite rotational directions, depending on the desired movement of door 12. Motor shaft 37 is operatively coupled to an output member, also referred to as drive shaft or output shaft 54 (FIG. 9), having a drive gear, also referred to as pinion gear 60, fixed thereto, such that pinion gear 60 rotates in response to rotation of motor shaft 37 to translate extensible rack 42 between the retracted and extended positions. A speed reducing/torque multiplying assembly 38, such as a gearbox, by way of example and without limitation, having one or more stages with a gear ratio allowing motor and geartrain assembly 34 to generate a rotational force having a high torque output by way of a very low rotational speed of electric motor 36 can be incorporated to couple motor shaft 37 to output shaft 54. However, any other arrangement of motor and geartrain assembly 34 can be used to establish the required rotational force without departing from the scope of the subject disclosure. Further yet, speed reducing/torque multiplying assembly 38 could be provided via any suitable arrangement of pulleys and belt(s), as desired to attain the desired speed reduction/torque multiplication desired. Electrical motor 36 is controlled by an electronics controller unit (ECU) shown illustratively as block 50, referred to hereafter as controller, in FIG. 2 which may include a microprocessor 110 and power electronics 92, such as H-bridge, FETS for example, controlled by the microprocessor 110. Controller 50 is electrically connected to command sources such as a door open or close switch 53, or to another controller 66 such as a Body Control Module, or an authentication controller such as PKE controller for example. As shown in FIGS. 12A and 12B, a power actuator 222 constructed in accordance with the disclosure can include an ECU 50 integrated directly into housing 226, if desired.

Power actuator 22 includes a mounting bracket 40 for establishing the connectable relationship with vehicle door 12 and the power actuator 22. The connectable relationship of the power actuator 22 with the vehicle door 12 via the mounting bracket 40 is illustrated as a pivotal connection, by way of example and without limitation, to allow the power actuator 22 to pivot about a pivot axis B, for example with rotations indicated as PA in FIG. 2. Mounting bracket 40 can be configured to be connectable to vehicle door 12 between the upper door hinge 16 and lower hinge 18, and for example connectable to the shutface 162. Shutface 162 can include a port or aperture for allowing extensible rack 42 to pass through the shutface 162, where such a port may be normally associated for allowing a door check link to pass therethough. As further shown in FIG. 2, this mounting of motor and geartrain assembly 34 disposes the power actuator 22 of power closure member actuation system 20 in close proximity to the pivot axis B. The mounting of motor and geartrain assembly 34 adjacent to the pivot axis B of vehicle door 12 minimizes the effect that power closure member actuation system 20 may have on a mass moment of inertia (i.e., pivot axis A) of vehicle door 12, thus improving or easing movement of vehicle door 12 between its open and closed positions. Reducing the mass of the actuator and moving the mass of the power actuator 22 closer to the pivot axis A reduces the mass of the door 14 and shifts the center of mass closer to the pivot axis C allowing for the motor 36 power and/or size to be reduced. In addition, as also shown in FIG. 2, the mounting of motor and geartrain assembly 34 closer to pivot axis A of vehicle door 12 allows power closure member actuation system 20 to be packaged in front of an A-pillar glass run channel and other internal door components and sheet metal panels associated with vehicle door 12 and thus avoids any interference with a glass window function of vehicle door 12. Put another way, power closure member actuation system 20 can be packaged in a portion of an internal door cavity 39 within vehicle door 12 that is not being used, and therefore reduces or eliminates impingement on existing hardware/mechanisms within vehicle door 12. Although power closure member actuation system 20 is illustrated as being mounted between the upper door hinge 16 and the lower hinge 18 of vehicle door 12, power closure member actuation system 20 can, as an alternative, also be mounted elsewhere within vehicle door 12 or even on vehicle body 14 without departing from the scope of the subject disclosure.

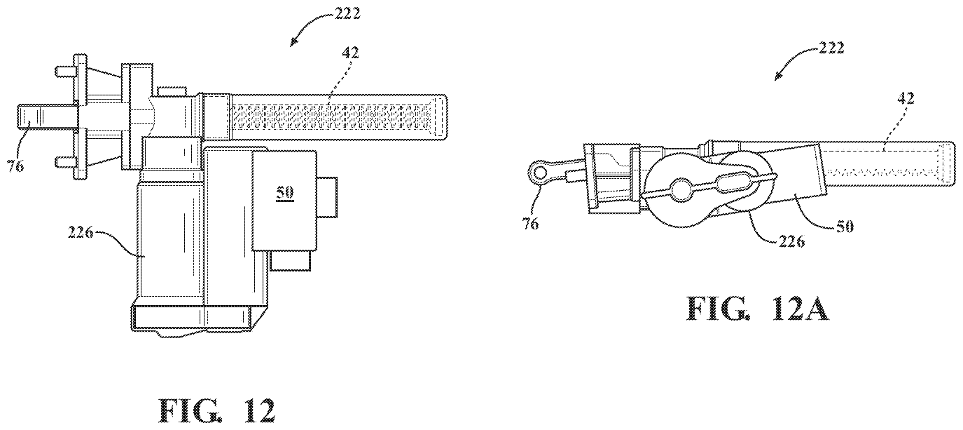

Power closure member actuation system 20 further includes the rotary drive mechanism that is rotatively driven by the power actuator 22. The rotary drive mechanism includes a coupling member, also referred to as intermediate shaft 56, rotatably driven by gearbox 38 of motor and geartrain assembly 34. Intermediate shaft 56 is coupled to output shaft 54 to drive a pinion gear 58 that is operably supported for rotation in response to rotation of motor drive shaft 37. Pinion gear 58 has a plurality of pinion teeth 62 for driving engagement with extensible rack 42, as discussed further hereafter. Intermediate shaft 56, as an optional configuration, can be coupled to output shaft 54 via a clutch and/or brake, such as an electromagnetic brake, referred to hereafter as clutch/brake assembly 64, wherein clutch and/or brake can be mechanical or electrical, and disposed between gearbox 38 and output shaft 54. The clutch/brake assembly 64 may engage and disengage using any suitable type of clutching mechanism such as, for example, a set of sprags, rollers, a wrap-spring, friction plates, or any other suitable mechanism. The clutch/brake assembly 64 may be provided to permit door 12 to be manually moved by the user between its open and closed positions relative to vehicle body 14. Such a clutch/brake assembly 64 could, for example, also be located between the motor drive shaft 37 of electric motor 36 and an input to gearbox 38. The location of this optional clutch/brake assembly 64 may be dependent based on, among other things, whether or not gearbox 38 includes back-drivable gearing. In another possible configuration, as shown in FIGS. 11 and 11A, a power actuator 122, constructed in accordance with the disclosure, may not be provided with an electromagnetically actuatable clutch/brake assembly 64, which as a result reduces the mass of the power closure member actuation system 20 and of the door 14, though including other components identified by similar reference numerals discussed above. Possibly, the gearbox 38 may include “back-drivable” gearing to allow a user to manually move the door 14 whereby the gearing of the gearbox 38 will be induced to rotate. Possibly, the gearbox 38 may alternatively include non-back-drivable gearing preventing a user to manually move the door 14, whereby the gearing of the gearbox 38 cannot be induced to rotate by movement of the door 14, but rather only an activation of the motor 22 will cause the gearing of gearbox 38 to rotate to move the door 14. The brake mechanism which prevents anyone of the rotation of the motor 36, the gearbox 38, or movement of the extensible rack 42 may also not be provided with the power closure member actuation system 20 to also further reduce mass of the power closure member actuation system 20 and the door 14.

To assist in accommodating angular motion due to swinging movement of door 12 relative to vehicle body 14, in addition to the aspects directed to extensible member 42 discussed in further detail below, the power closure member actuation system 20 can further includes a pivotal connection 45 disposed between the vehicle body 14 and a proximal end, also referred to as first end 44, of extensible member 42. A distal end, also referred to as second end 46, of extensible member 42 is configured to reciprocate into and out of cavity 39 as extensible member 42 is driven by the gearbox 38 in response to selective actuation of motor 36. Illustratively, connection 45 is a pin and socket type connection allowing pivotal movement of the extensible member 42 about an axis C, which extends parallel or substantially parallel to pivot axis A of the door 14 and to the pivot axis B of the power-operated actuator mechanism 22. Translation of extensible member 42 via operation of motor and geartrain assembly 34 functions to push the door 12 away from the vehicle body 14 when the drive shaft 42 is retracted from the cavity 39 and to pull the door 12 towards the vehicle body 14 when the extensible member 42 is translated into the cavity 39. With motor and geartrain assembly 34 connected to vehicle door 12 adjacent to the shut face 162, second end 46 of extensible member 42 may reciprocate and swing within cavity 39 as extensible member 42 reciprocates R within gearbox 38. Based on available space within door cavity 39, second end 46 of extensible member 42 may avoid collision with internal components within cavity 49 as the power-operated actuator mechanism 22 swings about axis B since for example the extensible member 42 is retracted out of the cavity 39 as the door 12 is opened.

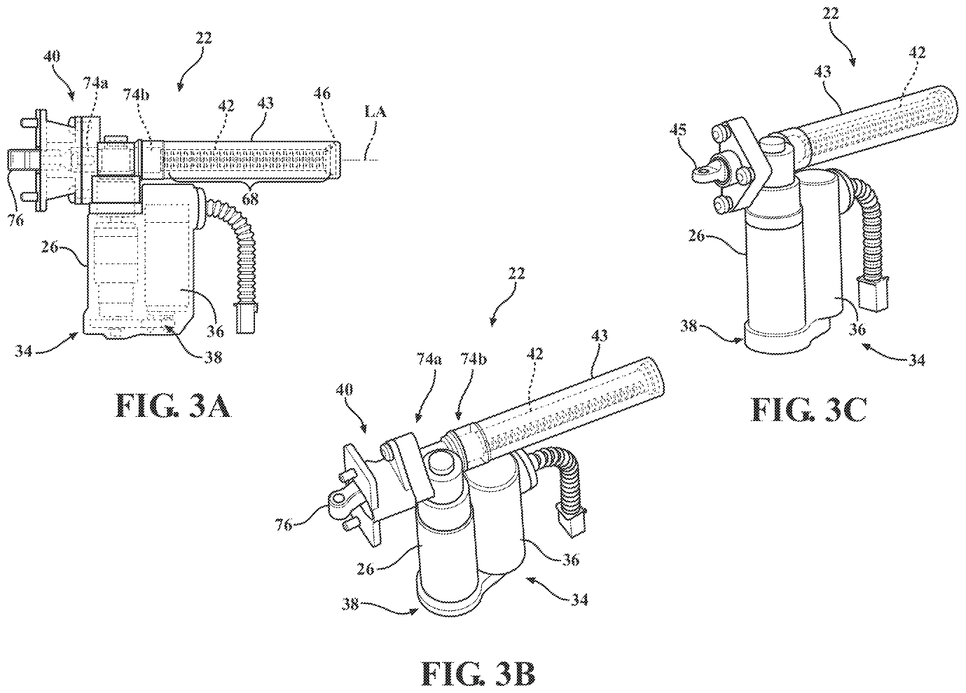

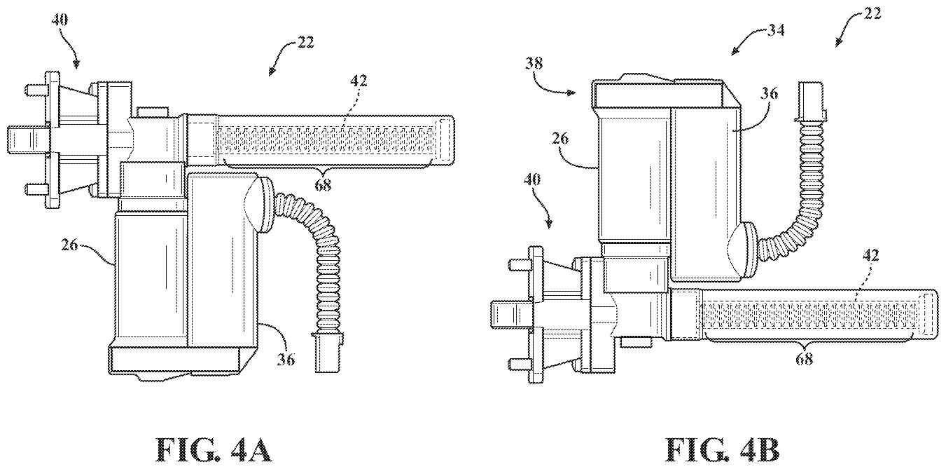

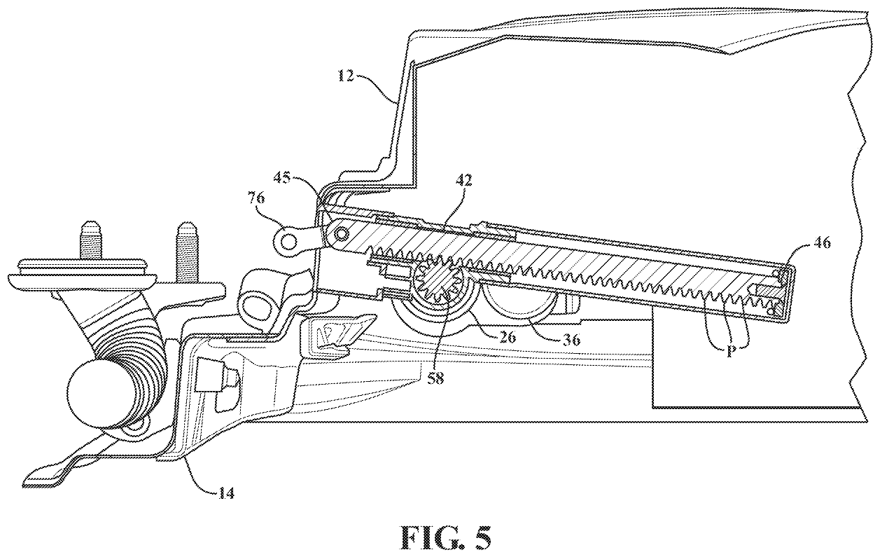

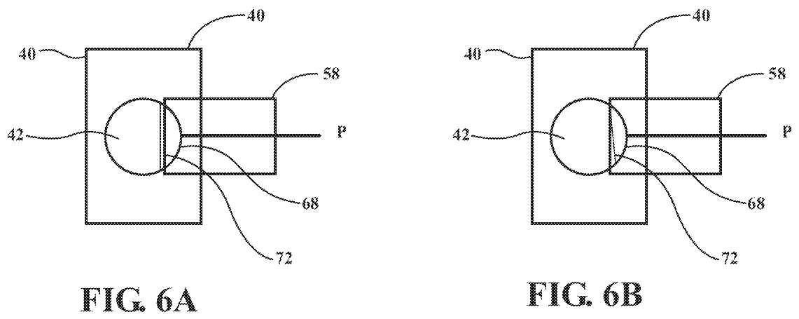

The extensible rack 42 can be supported for translation within an enclosed cover 43, such that cover 43 protects extensible rack 42 against exposure to contamination. Extensible rack 42 has a plurality of rack teeth 68 configured for meshed engagement with pinion teeth 62. The rack teeth 68 of extensible rack 42 are formed to inhibit binding between extensible rack 42 and pinion gear 58, thereby facilitating smooth movement of door 12 between the open and closed positions, while also minimizing the stress/strain imparted on electric motor 36. To inhibit jamming between extensible rack 42 and pinion gear 58, the rack teeth 68 have circumferentially extending, arcuate outer peaks P, as viewed looking along a longitudinal axis LA (FIG. 3A) of the extensible rack 42, wherein the arcuate outer peaks P of rack teeth 68 allow relative pivotal movement about the longitudinal axis LA between the rack teeth 68 and the pinion teeth 62. Accordingly, extensible rack 42 and pinion gear 58 are free to pivot in an oscillating fashion about longitudinal axis LA relative to one another, thus, removing pivotal constrains therebetween.

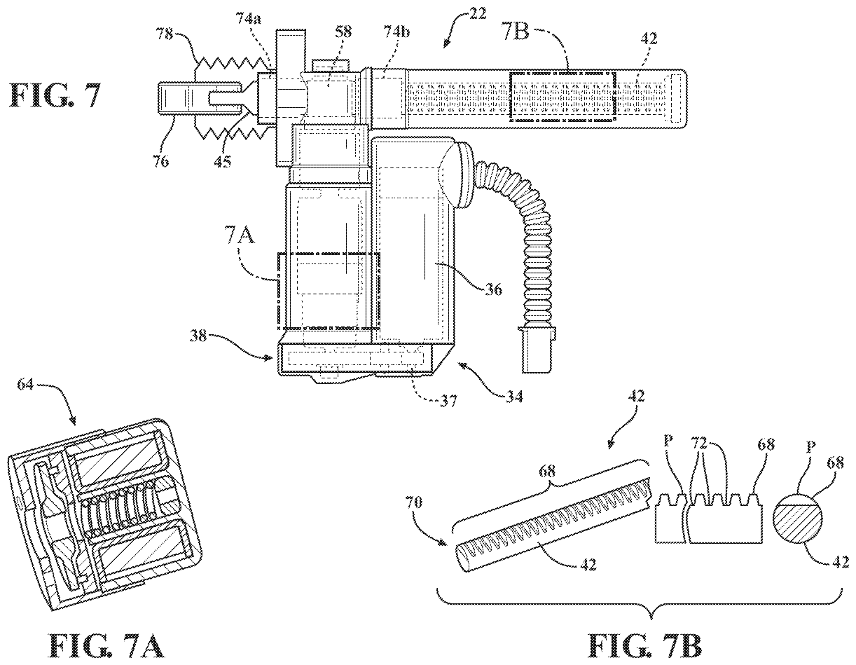

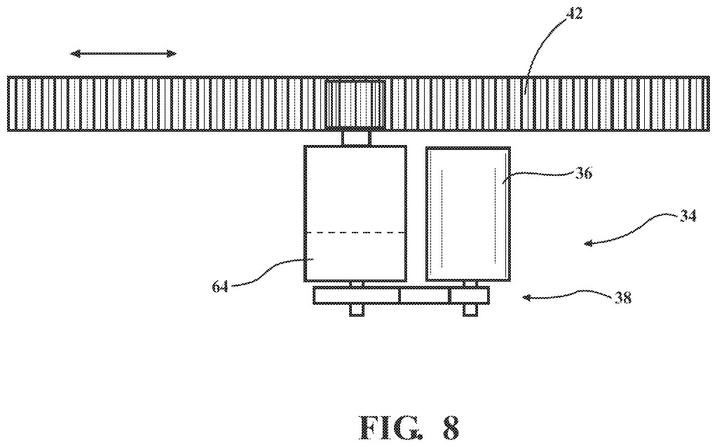

In accordance with an aspect of the disclosure, the extensible rack 42 can be formed having a generally cylindrical rack body 70 extending between first and second ends 44, 46, with the rack teeth 68 being formed in a cylindrical outer surface of the extensible rack 42. Each of the rack teeth 68 extends from the arcuate outer peak, defined by the cylindrical outer surface of rack body 70, radially inwardly toward the longitudinal axis LA to a valley of the rack teeth 68, also referred to as root 72 (FIG. 7B). The roots 72 of rack teeth 68 can be formed being linearly straight, wherein the linearly straight roots 72 can further be formed to extend generally transversely to longitudinal axis LA.

Extensible rack 42, having a cylindrical outer surface, as discussed above, is able to be directly supported by at least one bearing, and in the non-limiting embodiment illustrated, by a pair of bearings 74. The bearings 74 are shown directly engaged with and supporting the extensible rack 42. The bearings 74 are shown disposed on opposite sides of pinion gear 58, with a first bearing 74a on one side of pinion gear 58 and a second bearing 74b on an opposite side of pinion gear 58. The bearings 74 can be provided as any suitable type of bearing, including journal type bearings having a circular inner bearing surface supporting extensible rack 42 for sliding movement along a direction of longitudinal axis LA as extensible rack 42 translates between its retracted and extended positions. With bearings 74a, 74b being able to support extensible rack 42 directly, power actuator 22 is able to be made having a reduced size and weight.

As shown in FIG. 7, an optional link 76 may be pivotably connected to first end 44, with link 76 being configured for pivotal connection to vehicle body 14. Further, a protective cover, also referred to as boot or bellows 78, may be disposed for expansion and contraction about extensible rack 42 to prevent contamination from contacting extensible rack 42 and from entering housing 26. Bellows 78 may be fixed at one end to link 76 and at an opposite end to housing 26. Accordingly, bellows 78 is free from attachment to extensible rack 42, thereby eliminating the need to extend the length of extensible rack 42 for attachment of bellows 78 thereto. As such, extensible rack 42 can be reduced in length, thereby further reducing the size and weight of power actuator 22. This further allows the pivot point of extensible rack 42 to be located closer to housing 26, such as in the door closed position, and further allows the length of link 76 to be increased, thus, optimizing the moment (torque) provided by link 76. It is to be recognized that bellows 78 is provided as a highly flexible member, thereby being able to flex in all directions to avoid imparting an unwanted bias or restriction for pivoting movement of link 76.

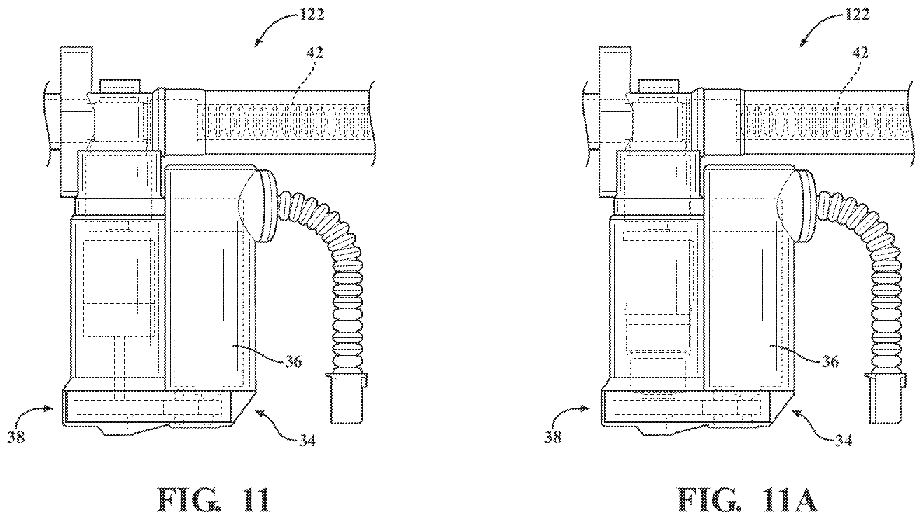

Extensible rack 42 can include a mechanical energy dampener assembly, referred to hereafter as dampener 79 (FIG. 10), configured for fixation to the second end 46 of extensible rack 42. Dampener includes an elastomeric ring 81 sized for close sliding receipt in cover 43, with elastomeric ring 81 being formed of a low friction dampening material, including rubber, by way of example and without limitation. Elastomeric ring 81 can be fixed to end 46 via plug 83 and washer 85, with elastomeric ring 81 being captured between plug 83 and washer 85.

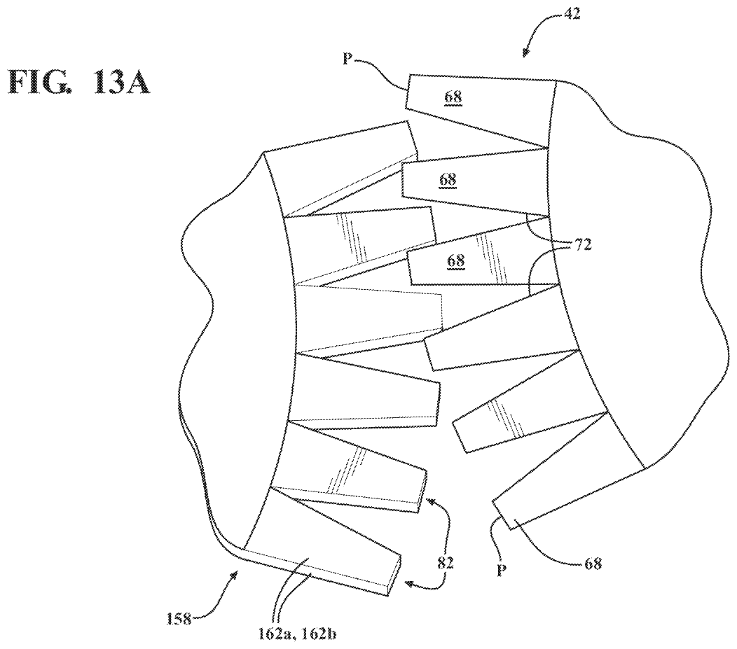

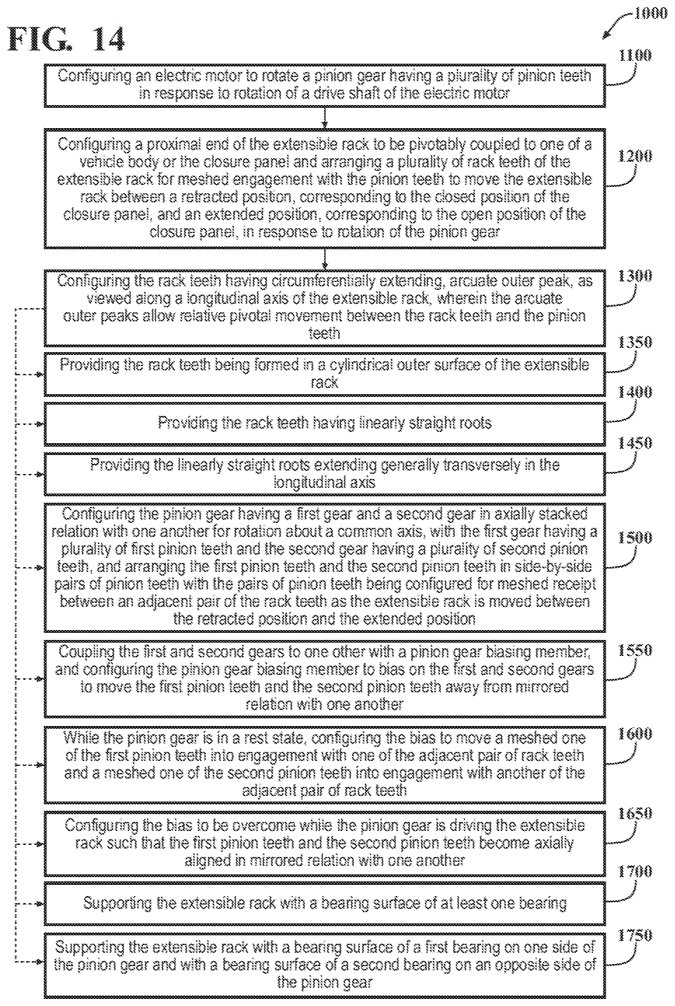

As shown in FIG. 13, a pinion gear 158 can be provided having a first gear 158a and a second gear 158b in axially stacked relation with one another for rotation about a common axis, also referred to as pinion axis 80. The first gear 158a has a plurality of first pinion teeth 162a and the second gear 158b has a plurality of second pinion teeth 162b, wherein the first pinion teeth 162a and the second pinion teeth 162b are arranged in pairs 82 (FIG. 13A) of pinion teeth 162a, 162b in substantially axially aligned, side-by-side relation with one another. Each of the pairs 82 of pinion teeth 162a, 162b are configured for meshed receipt between an adjacent pair of rack teeth 68 as the extensible rack 42 moves between the retracted position and the extended position. The first and second gears 158a, 158b are coupled to one another by a pinion gear biasing member 84. The pinion gear biasing member 84 can be provided as a coil spring, by way of example and without limitation, having a first end 86 fixedly attached in an opening 87 of first gear 158a and a second end 88 fixedly attached in an opening 89 of second gear 158b. Pinion gear biasing member 84 is configured to impart a bias on the first and second gears, with the bias tending to move the first pinion teeth 162a and the second pinion teeth 162b away from mirrored relation with one another, as shown in FIG. 13A. Accordingly, while pinion gear 158 is in a rest state, when electric motor 36 is de-energized, the bias imparted by pinion gear biasing member 84 moves a meshed one of the first pinion teeth 162a into engagement with one of the adjacent pair of rack teeth 68 and a meshed one of the second pinion teeth 162b into engagement with another of the adjacent pair of rack teeth 68. As such, the adjacent rack teeth 68 in meshed engagement with the pair 82 of pinion teeth 162a, 162b are both in contact with pinion gear 158, thereby avoiding any slop, also referred to as play, from being formed between extensible rack 42 and pinion gear 158. Accordingly, when electric motor 36 is energized, no time is needed to take up play, nor is noise generated from an impact of pinion teeth 162a, 162b with rack teeth 68. When electric motor 36 is energized to bring pinion gear 158 into a driven state, the bias imparted by pinion gear biasing member 84 on first and second gears 158a, 158b is overcome, whereupon the first pinion teeth 162a and the second pinion teeth 162b are brought into axially aligned, mirrored relation with one another to simultaneously engage the same surface(s) of rack teeth 68. Upon de-energization of electric motor 36, the bias imparted by pinion gear biasing member 84 on first and second gears 158a, 158b returns first and second gears 158a, 158b, and the respective teeth 162a, 162b thereof, to their axially misaligned relation with one another, as discussed above. To fixedly maintain first and second gears 158a, 158b in coupled relation with one another, a hub 90 can be disposed through respective central hub openings 92a, 92b of first and second gears 158a, 158b and retained therein, such as via a flange 93 on one end of hub 92 and a snap ring 94 fixed to an opposite end of hub 92, by way of example and without limitation. Further, a low friction washer 96 can be disposed between snap ring 94 and first gear 158a, as illustrated in the non-limiting embodiment.

A method 1000 of configuring a power actuator 22, 122, 222 to inhibit binding of an extensible rack 42 of the power actuator 22, 122 while moving a closure panel 12 of a motor vehicle 10 between a closed position and an open position is provided. The method 1000 includes a step 1100 of configuring an electric motor 36 to rotate a pinion gear 58, 158 having a plurality of pinion teeth 62, 162a, 162b in response to rotation of a drive shaft 37 of the electric motor 36. Further, a step 1200 of configuring a proximal end 45 of the extensible rack 42) to be pivotably coupled to one of a vehicle body 14 or the closure panel 12 and arranging a plurality of rack teeth 68 of the extensible rack 42 for meshed engagement with the pinion teeth 62, 162a, 162b to move the extensible rack 42 between a retracted position, corresponding to the closed position of the closure panel 12, and an extended position, corresponding to the open position of the closure panel 12, in response to rotation of the pinion gear 58, 158. Further yet, a step 1300 of configuring the rack teeth 68 having circumferentially extending, arcuate outer peaks P, as viewed along a longitudinal axis LA of the extensible rack 42, wherein the arcuate outer peaks P allow relative pivotal movement between the rack teeth 68 and the pinion teeth 62, 162a, 162b.

In accordance with a further aspect of the disclosure, the method 1000 can further include a step 1350 of providing the rack teeth 68 being formed in a cylindrical outer surface of the extensible rack 42.

In accordance with a further aspect of the disclosure, the method 1000 can further include a step 1400 of providing the rack teeth 68 having linearly straight roots 72.

In accordance with a further aspect of the disclosure, the method 1000 can further include a step 1450 of providing the linearly straight roots 72 extending generally transversely to the longitudinal axis LA.

In accordance with a further aspect of the disclosure, the method 1000 can further include a step 1500 of configuring the pinion gear 58, 158 having a first gear 158a and a second gear 158b in axially stacked relation with one another for rotation about a common axis 80, with the first gear 158a having a plurality of first pinion teeth 162a and the second gear 158b having a plurality of second pinion teeth 162b, and arranging the first pinion teeth 162a and the second pinion teeth 162b in side-by-side pairs 82 of pinion teeth, with individual ones of the pairs 82 of pinion teeth being configured for meshed receipt between an adjacent pair of the rack teeth 68 as the extensible rack 42 is moved between the retracted position and the extended position.

In accordance with a further aspect of the disclosure, the method 1000 can further include a step 1550 of coupling the first and second gears 158a, 158b to one another with a pinion gear biasing member 84, and configuring the pinion gear biasing member 84 to impart a bias on the first and second gears 158a, 158b to move the first pinion teeth 162a and the second pinion teeth 162b away from mirrored relation with one another.

In accordance with a further aspect of the disclosure, the method 1000 can further include a step 1600 of, while the pinion gear 158 is in a rest state, configuring the bias to move a meshed one of the first pinion teeth 162a into engagement with one of the adjacent pair of rack teeth 68 and a meshed one of the second pinion teeth 162b into engagement with another of the adjacent pair of rack teeth 68.

In accordance with a further aspect of the disclosure, the method 1000 can further include a step 1650 of configuring the bias to be overcome while the pinion gear 158 is driving the extensible rack 42 such that the first pinion teeth 162a and the second pinion teeth 162b become axially aligned in mirrored relation with one another.

In accordance with a further aspect of the disclosure, the method 1000 can further include a step 1700 of supporting the extensible rack 42 with a bearing surface of at least one bearing 74a, 74b.

In accordance with a further aspect of the disclosure, the method 1000 can further include a step 1750 of supporting the extensible rack 42 with a bearing surface of a first bearing 74a on one side of the pinion gear 58, 158 and with a bearing surface of a second bearing 74b on an opposite side of the pinion gear 58, 158.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power actuator for moving a closure panel of a motor vehicle between a closed position and an open position, comprising:
a housing;
an electric motor supported by said housing and being configured to rotate a motor drive shaft;
a pinion gear operably supported for rotation in response to rotation of said motor drive shaft, said pinion gear having a plurality of pinion teeth; and
an extensible rack having a plurality of rack teeth configured for meshed engagement with said pinion teeth, said extensible rack having a proximal end configured to be pivotably coupled to one of a vehicle body or the closure panel, said extensible rack being configured to move between a retracted position, corresponding to the closed position of the closure panel, and an extended position, corresponding to the open position of the closure panel, in response to rotation of said pinion gear, said rack teeth of said extensible rack having circumferentially extending, arcuate outer peaks, as viewed along a longitudinal axis of said extensible rack, wherein said arcuate outer peaks of said rack teeth allow relative pivotal movement between said rack teeth and said pinion teeth.

2. The power actuator of claim 1, wherein said rack teeth are formed in a cylindrical outer surface of said extensible rack.

3. The power actuator of claim 1, wherein each of said rack teeth extends from said arcuate outer peak radially inwardly toward said longitudinal axis to a linearly straight root.

4. The power actuator of claim 3, wherein said linearly straight roots extend generally transversely to said longitudinal axis.

5. The power actuator of claim 1, wherein said pinion gear includes a first gear and a second gear in axially stacked relation with one another for rotation about a common axis, said first gear having a plurality of first pinion teeth and said second gear having a plurality of second pinion teeth, said first pinion teeth and said second pinion teeth being arranged in pairs of pinion teeth in side-by-side relation with one another, each of said pairs of pinion teeth being configured for meshed receipt between an adjacent pair of said rack teeth as said extensible rack moves between the retracted position and the extended position.

6. The power actuator of claim 5, wherein said first and second gears are coupled to one another by a pinion gear biasing member, said pinion gear biasing member imparting a bias on said first and second gears, said bias tending to move said first pinion teeth and said second pinion teeth away from mirrored relation with one another.

7. The power actuator of claim 6, wherein, while said pinion gear is in a rest state, said bias moves a meshed one of said first pinion teeth into engagement with one of said adjacent pair of rack teeth and a meshed one of said second pinion teeth into engagement with another of said adjacent pair of rack teeth.

8. The power actuator of claim 7, wherein, while said pinion gear is in a driven state, said bias is overcome, wherein said first pinion teeth and said second pinion teeth are brought into axially aligned, mirrored relation with one another.

9. The power actuator of claim 1, further including at least one bearing engaged with and supporting said extensible rack.

10. The power actuator of claim 9, wherein said at least one bearing includes a first bearing on one side of said pinion gear and a second bearing on an opposite side of said pinion gear.

11. The power actuator of claim 9, wherein said at least one bearing has a circular inner bearing surface supporting said extensible rack for sliding movement therealong.

12. A method of configuring a power actuator to inhibit binding of an extensible rack of the power actuator while moving a closure panel of a motor vehicle between a closed position and an open position, comprising:
configuring an electric motor to rotate a pinion gear having a plurality of pinion teeth in response to rotation of a drive shaft of the electric motor;
configuring a proximal end of the extensible rack to be pivotably coupled to one of a vehicle body or the closure panel and arranging a plurality of rack teeth of the extensible rack for meshed engagement with the pinion teeth to move the extensible rack between a retracted position, corresponding to the closed position of the closure panel, and an extended position, corresponding to the open position of the closure panel, in response to rotation of the pinion gear; and
configuring the rack teeth having circumferentially extending, arcuate outer peaks, as viewed along a longitudinal axis of the extensible rack, wherein the arcuate outer peaks allow relative pivotal movement between the rack teeth and the pinion teeth.

13. The method of claim 12, further including providing the rack teeth being formed in a cylindrical outer surface of the extensible rack.

14. The method of claim 12, further including providing the rack teeth having linearly straight roots.

15. The method of claim 14, further including providing the linearly straight roots extending generally transversely to the longitudinal axis.

16. The method of claim 12, further including configuring the pinion gear having a first gear and a second gear in axially stacked relation with one another for rotation about a common axis, with the first gear having a plurality of first pinion teeth and the second gear having a plurality of second pinion teeth, and arranging the first pinion teeth and the second pinion teeth in side-by-side pairs of pinion teeth with the pairs of pinion teeth being configured for meshed receipt between an adjacent pair of the rack teeth as the extensible rack is moved between the retracted position and the extended position.

17. A power actuator for moving a closure panel of a motor vehicle between a closed position and an open position, comprising:
a housing;
an electric motor supported by said housing and being configured to rotate a motor drive shaft;
a pinion gear operably supported for rotation in response to rotation of said motor drive shaft, said pinion gear having a plurality of pinion teeth; and
an extensible rack having a plurality of rack teeth extending along an longitudinal axis of said extensible rack, the plurality of rack teeth configured for meshed engagement with said pinion teeth, said extensible rack having a proximal end configured to be pivotably coupled to one of a vehicle body or the closure panel, said extensible rack being configured to move between a retracted position, corresponding to the closed position of the closure panel, and an extended position, corresponding to the open position of the closure panel, in response to rotation of said pinion gear, wherein the extensible rack is allowed to rotate about the longitudinal axis during the extensible rack moving between the retracted position and the extended position.

18. The power actuator of claim 17, wherein the extensible rack has at least a portion of its cross-sectional circumference that is circular.

19. The power actuator of claim 18, further comprising at least one bearing having an inner circumference adapted for surrounding part of the extensible rack.

20. The power actuator of claim 17, further comprising a link connected to the extensible rack and to the one of the vehicle body or the closure panel.
